(19) United States
(12) Patent Application Publication
(10) Pub. No.: US 2006/0250642 A1
(43) Pub. Date: Nov. 9, 2006

(54) Method and System for Printing Data Using a Message Signaling Service, and a Corresponding Computer Program and a Corresponding Computer-Readable Storage Medium

(75) Inventors: Bernd Trappe, Berlin (DE); Jochen Schieberlein, Berlin (DE); Danny Preussler, Berlin (DE)

Correspondence Address: NORRIS, MCLAUGHLIN & MARCUS, P.A., 875 THIRD AVE, 18TH FLOOR, NEW YORK, NY, 10022, US

(73) Assignee: ThinPrint GmbH, Berlin (DE)

(21) Appl. No.: 11/279,404

(22) Filed: Apr. 12, 2006

(30) Foreign Application Priority Data
Apr. 15, 2005 (DE) 10 2005 018 299.2
Apr. 19, 2005 (DE) 10 2005 018 971.7

(51) Int. Cl. G06F 3/12

(52) U.S. Cl. 358/1.15

(57) ABSTRACT

A method and a system for printing data with a message-push-service are described. E-mail texts and e-mail attachments can be printed by message-push-enabled terminals, such as BlackBerry devices, via Bluetooth-enabled printers. Data received at a MSS (message signaling service) server are signaled to a terminal which can access the received data at the MSS server via a mobile radio link. The terminal sends a print request to the MSS server and/or to a data processing system that controls printing. A computer program installed on the MSS server/data processing system automatically initiates transmission of the requested data from the MSS server to a print server which generates print data. The print data are transmitted from the print server to the mobile terminal and from the mobile terminal to a selected printer, where the data are printed. A corresponding computer program and a computer-readable storage medium are also disclosed.

### FIELD OF THE INVENTION

The invention is directed to a method and a system for printing data using a message signaling system (for example a message push service) and a corresponding computer program and a corresponding computer-readable storage medium, which can be used in particular for printing e-mail texts and e-mail attachments of message-push-enabled terminals, such as BlackBerry devices, with Bluetooth-enabled printers.

### BACKGROUND OF THE INVENTION

Message-push-enabled terminals, in particular e-mail-push-enabled terminals are known, for example, by the name BlackBerry devices. These devices are specifically designed for displaying and processing of e-mail, but still have a significant deficiency in that they are unable to output e-mails and e-mail attachments directly to a printer.

Solutions have been described which provide print option for such (BlackBerry) devices. However, this print option has only limited application as printing can only be accomplished by using a network printer or a fax machine.

It would therefore be desirable to provide a method and a system for printing data using a message signaling service and a corresponding computer program and a corresponding computer-readable storage medium, which obviates certain disadvantages of conventional solutions and particularly enables printing on printers which are locally connected to a mobile terminal.

### SUMMARY OF THE INVENTION

According to one aspect of the invention, a method is provided wherein a terminal capable of cooperating with a message signaling service, for example a message-push-enabled terminal, can address any printers, in particular printers locally connected to the terminal. The method can be used to print data when using a message signaling service (MSS), wherein data received at a server of the message signaling system (MSS) are signaled to a terminal and the data received at the MSS server can be accessed by the terminal by using a mobile radio link. A request for printing the data is transmitted by the terminal to the MSS server and/or to a data processing system controlling printing, with a computer program installed on the MSS server and/or the data processing system controlling printing automatically initiating the transmission of the requested data from the MSS server to a print server. The printing process is started on the print server, and the data generated by the print process are transmitted from the print server to the mobile terminal and from the mobile terminal to a predetermined printer, where the data are printed.

In one advantageous embodiment, the message signaling service (MSS) may be an e-mail push service. The data received at the MSS server can also be e-mails (with or without e-mail attachment) and/or messages sent via a Short Message Service (SMS) and/or messages sent via a Multimedia Message Service (MMS).

According to the invention, the e-mail attachments to be printed are transmitted to a print server. This can be accomplished by fetching the e-mail attachments from the MSS server by using a special computer program and providing the e-mail attachments to the print server. The print server then renders the e-mail attachments to be printed and transmits the print data, preferably as a data stream, to the mobile terminal. Accordingly, the data are immediately transmitted to the mobile terminal in the form generated by the print server, so that the print job can already be started when the first transmitted data are received. This approach has the advantage that the print data need not be temporarily stored on the terminal. Another advantage is the quick reaction of the system. The user immediately notices progress.

According to another advantageous embodiment, the employed a mobile radio link may include Global System for Mobile Communications (GSM), General Packet Radio Service (GPRS), Code Division Multiple Access (CDMA), and/or Universal Mobile Telecommunications System (UMTS).

According to yet another advantageous embodiment, the print server can transmit the data generated by the printing process from the print server to the mobile terminal via a communication link established between the MMS server and the mobile terminal. Advantageously, the Mobile Data Service (MDS) can be used to transmit data between the terminal and the MSS server and/or between the terminal and the data processing system controlling printing.

According to still another advantageous embodiment, for transmitting data between the mobile terminal and the MMS server and/or between the mobile terminal and the data processing system controlling the printing, the mobile terminal can automatically set up a connection to the data processing system controlling the printing, if the mobile terminal cannot be addressed by the server, and the data generated by the printing process can be transmitted via this connection to the mobile terminal.

According to another advantageous embodiment, the data generated by the printing process can be transmitted from the mobile terminal to the predetermined printer via a Bluetooth interface or an infrared interface.

According to another aspect of the invention, a system using a message signaling service includes at least one message signaling server (MSS server) and at least one terminal cooperating with the message signaling service, wherein data received on the MSS server are signaled to the terminal and the data received at the MSS server can be accessed by the terminal by using a mobile radio link. The system is configured so that data can be printed by transmitting a request for printing data from the terminal to the MSS server and/or to a data processing system controlling printing, and that the transmission of the requested data from the MSS server to a print server is automatically initiated by a computer program installed on the MSS server and/or the data processing system controlling printing. The printing process on the print server is then started, and the data generated by the print process are transmitted from the print server to the mobile terminal and from the mobile terminal to a predetermined printer, where the data are printed.

According to yet another aspect of the invention, a computer program for printing data enables a data processing system, after the computer program is loaded into the memory of the data processing system, to execute a process for printing data using a message signaling service. Data received on the MSS server are signaled to the terminal and the data received at the MSS server can be accessed by the terminal by using a mobile radio link. The terminal sends a request for printing data to the MSS server and/or to a data processing system controlling printing, the transmission of the requested data from the MSS server to a print server is automatically initiated by a computer program installed on the MSS server and/or the data processing system controlling printing, the printing process is started on the print server, and the data generated by the print process are transmitted from the print server to the mobile terminal and from the mobile terminal to a predetermined printer, where the data are printed.

Such computer programs can be provided, for example, in a data or communication network which facilitates downloading (fee-based or for free, freely accessible or password-protected). The provided computer programs can be downloaded, for example, from an electronic data network, for example from the Internet, to a data processing system connected to the data network.

According to another aspect of the invention, the method for printing data can be executed by using a computer-readable storage medium storing a program which enables a data processing device, after the program is loaded into the memory of the data processing device, to execute a process for printing data using a message signaling service, wherein data received on a server of the message signaling service (MSS) are signaled to the terminal and the data received at the MSS server can be accessed by the terminal by using a mobile radio link. The terminal sends a request for printing data to the MSS server and/or to a data processing system controlling printing, and a computer program installed on the MSS server and/or the data processing system controlling printing automatically initiates the transmission of the requested data from the MSS server to a print server. The printing process is then started on the print server, and the data generated by the print process are transmitted from the print server to the mobile terminal and from the mobile terminal to a predetermined printer, where the data are printed.

The invention can advantageously provide message-push-enabled terminals, for example BlackBerry devices, with an additional print option while taking advantage of the existing architecture of message-push-servers.

With the invention, printing is directly initiated by the device, because the print function is integrated in the BlackBerry operating system. Accordingly, no web site is called to initiate printing.

Routing the messages (e.g., e-mails) from the message-push-server to a print server, which is integrated in a system that processes data to be outputted, in particular printed (in the following referred to as Output Processing System [OPS]), may occur automatically in the background during printing and may be transparent to the user of the terminal.

According to another advantageous embodiment of the invention, the print function is integrated in the architecture of the message-push-server, in particular with BlackBerry devices. The Mobile Data Services (MDS) can then also be used for printing, and data transfer from the BlackBerry devices to the message-push server during initiation of the print process as well as transmission of the print shop from the print server to the BlackBerry terminal can occur via the secure MDS tunnel.

According to yet another advantageous embodiment of the invention, the configuration data can be stored in the User IT Policies of a message-push-server (BlackBerry-enterprise-servers), from where they are transmitted to the terminals.

The systems and methods of the invention therefore extend the functionality of mobile terminals adapted to cooperate with message signaling services by providing a print option (whereby any printer, preferably Bluetooth-enabled printers, can be used). A message signaling service includes at least one message signaling server (MSS server) and at least one mobile terminal cooperating with the message signaling service, wherein the at least one MSS server signals to the at least one mobile terminal cooperating with the message signaling service receipt of messages. Also provided is a computer program for processing data for output, in particular printing.

In one embodiment, the computer program includes at least three program modules: a first program module installed on the MSS server, a second program module installed on the mobile terminal cooperating with the message signaling service, and a third program module installed on a data processing system controlling printing. Data are printed by using the additionally provided print option, in that a request to print data is transmitted from the mobile terminal cooperating with message signaling service to the MSS server and/or the data processing system controlling printing. Transmission of requested data is automatically initiated from the MSS server to a print server through the first program module installed on the MSS server and/or through the third program module installed on the data processing system controlling printing. The printing process is then started on the print server, and the data generated by the printing process are transmitted from the print server to the mobile terminal cooperating with the message signaling services and from this terminal to a predetermined printer, where the data are printed.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an exemplary network environment with e-mail-push-enabled terminals;

FIG. 2 shows a schematic diagram with a system according to the invention with printing capability integrated an existing architecture of a message push service;

FIG. 3 shows a schematic process flow for the function “Print E-Mail”; and

FIG. 4a-c show a schematic process flow for printing e-mails specifically from a BlackBerry terminal.

### DESCRIPTION OF EXEMPLARY EMBODIMENTS

Throughout all the Figures, same or corresponding elements are generally indicated by same reference numerals. These depicted embodiments are to be understood as illustrative of the invention and not as limiting in any way. In certain instances, details which are not necessary for an understanding of the present invention or which render other details difficult to perceive may have been omitted.

The invention will be described hereinafter specifically for use with BlackBerry devices. However, the invention is not limited to BlackBerry devices, but can also be used with other message-push-enabled terminals, for example Symbian Handies.

The invention provides a method and a system which enables printing e-mail attachments and e-mail texts via an e-mail-push-enabled terminal, such as a BlackBerry terminal. For this purpose, a computer program module, in the following referred to as client module, is provided on the e-mail-push-enabled terminal, wherein the computer program module enables communications and data transfer between client module and server when the print function is called.

A BlackBerry device is print-enabled by installing the client module on the device. When the print function according to the invention is installed on a BlackBerry device, the configuration entries for connecting to the server of the OPS (i.e., to the data processing system controlling the print operation) are automatically stored in the User Policies of the BlackBerry server, from where they are transferred to the terminals (server name/IP address of the server of the OPS, Port name, PIN of the terminal, etc.).

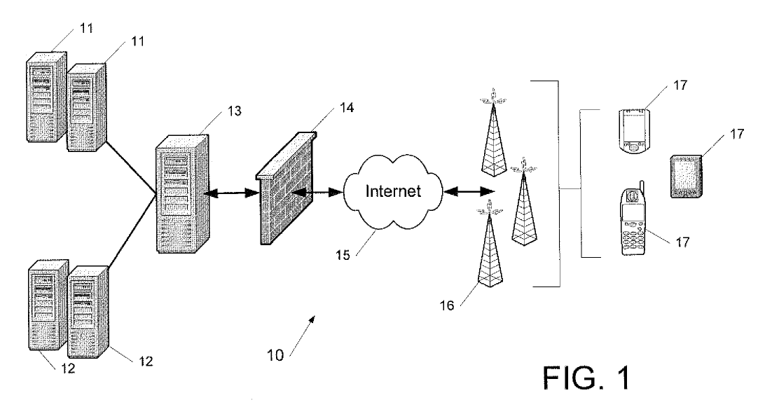

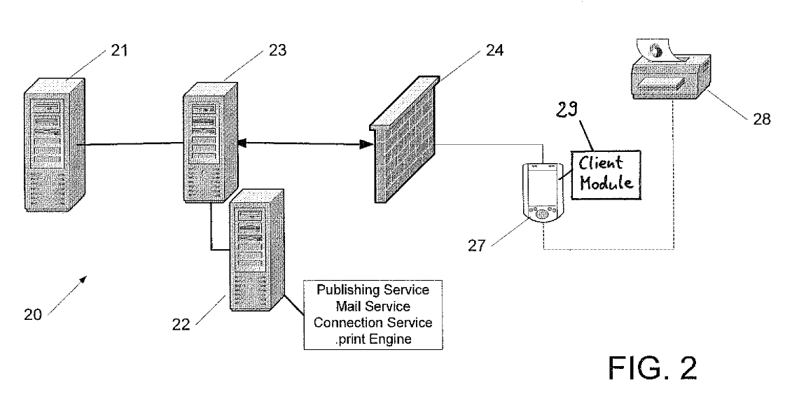

Turning now to the drawing, and in particular to FIG. 1, there is shown a typical environment 10 for using e-mail-push-enabled terminals. The environment 10 includes one or more Microsoft Exchange servers 11, one or more Corporate Application servers 12, a BlackBerry enterprise server 13 with a client module (not shown). The client module is then available for the mail systems Microsoft Exchange and Lotus Notes running on the Microsoft Exchange servers 11 and Corporate Application servers 12.

The BlackBerry terminals or BlackBerry-enabled terminals 17 are linked via a wireless communication network 16 (optionally via the Internet 15) with the BlackBerry enterprise server 13. The additional communication servers, such as the Microsoft Exchange Servers 11 and/or Corporate Applications Servers 12 transmit to the BlackBerry enterprise server 13 information about incoming data (e.g., e-mails) intended for registered BlackBerry terminals 17. The BlackBerry enterprise server 13 is almost always protected by a firewall 14. When the BlackBerry enterprise server 13 receives information about incoming data, a user of a BlackBerry terminal receives corresponding information via the wireless link 16.

When new e-mails arrive on the BlackBerry device 17, the e-mails can optionally be printed. The user opens the desired e-mail and selects the print function. The document to be printed (e-mail texts or attachment) is then automatically routed in the background to a special program, the Mail Service, running on the server of the OPS. The print job is then generated and subsequently transmitted back to the terminal via the secure MDS (Mobile Data Service) tunnel of the BlackBerry server. The user can then select a suitable printer driver from different printer drivers (=list of the printer types installed on the server of the OPS).

Access to e-mail attachments to be printed is much more complex than printing normal files stored in a file system. The differences between accessing a file system (also accessing file systems distributed over several machines) and the internal flow of a mail server when outputting e-mail attachments to human users or machines will now be briefly described.

Any type of file administration is based on a file system. This functionality is provided by the operating system. Accordingly, each program running on a computer or computer system has access to this file system. The term “Fileserver” refers to a program or a machine for providing secure operating system functionality. This is achieved, for example, by regularly making backup copies, storing the data on several data carriers, use of error detection and correction mechanisms. The files are accessed by the functions provided by the operating system.

The mail server functionality is an application program running on the operating system. However, the mail server does not provide the data via the interfaces of the operating system, but has instead dedicated interfaces exclusively for the exchange of data. These include typically the functions “Download Mail” and “Send Mail.” The mail server accesses its stored data via functions of the operating system.

The relationship (or interdependence) between a fileserver and a mail server can be described as follows:

The data managed by the mail server can be located on the file system managed by the fileserver. The data are seen by the fileserver, for example, as a text file. The mail server uses the functionality of the fileserver. However, there is no inverse relationship. The fileserver is not able to use the functionality of the mail server.

In a particular embodiment, the mail service detaches the mail attachments from the e-mail and temporarily stores them on the server of the OPS. The mail service is also responsible for user administration and license confirmation, because the e-mail address of each BlackBerry user authorized to print is stored.

In the print option for BlackBerry devices according to the invention, the e-mails and attachments are stored by the mail service in directories. These directories are only temporary and transparent to the user. For example, for printing an e-mail text, the client module generates an e-mail with an attachment consisting of the original e-mail text (.txt format) and transmits the e-mail to the mail service. The user need not call an additional program. Because the print option is completely integrated in the BlackBerry interface, the user is unaware of the processes running in the background. The expanded functionality of the BlackBerry device resulting from the inventive integration of the system for processing data for printing is only indicated by an additional menu item PRINT.

The added print function advantageously supports different printer languages, such as PCL and PostScript and the like. Mobile Bluetooth-enabled printers and printers with a USB or LPT interface, if provided with a Bluetooth adapter, can also be addressed. All printable formats can then be outputted.

The additional integrated print option for BlackBerry devices therefore enables printing of different documents with a BlackBerry device. Documents can be accessed in their original formats, i.e., also in formats which often cannot be displayed in the attachment viewer of the BlackBerry device.

As described above, existing functions and processes generally used for communication between the e-mail-push-enabled terminals can advantageously be used to enhance the functionality of the e-mail-push-enabled terminals by adding a print function.

FIG. 2 shows schematically a diagram of a data processing system 20 according to the invention which controls printing. System 20 includes the aforedescribed Microsoft Exchange, Lotus Notes, or another e-mail server 21, and the BlackBerry enterprise server 23. System 20 also includes an output processing server (OPS server) 22, 504 with a publishing service 506, a mail service 512, a connection service 510, and a computer program (.print Engine 508).

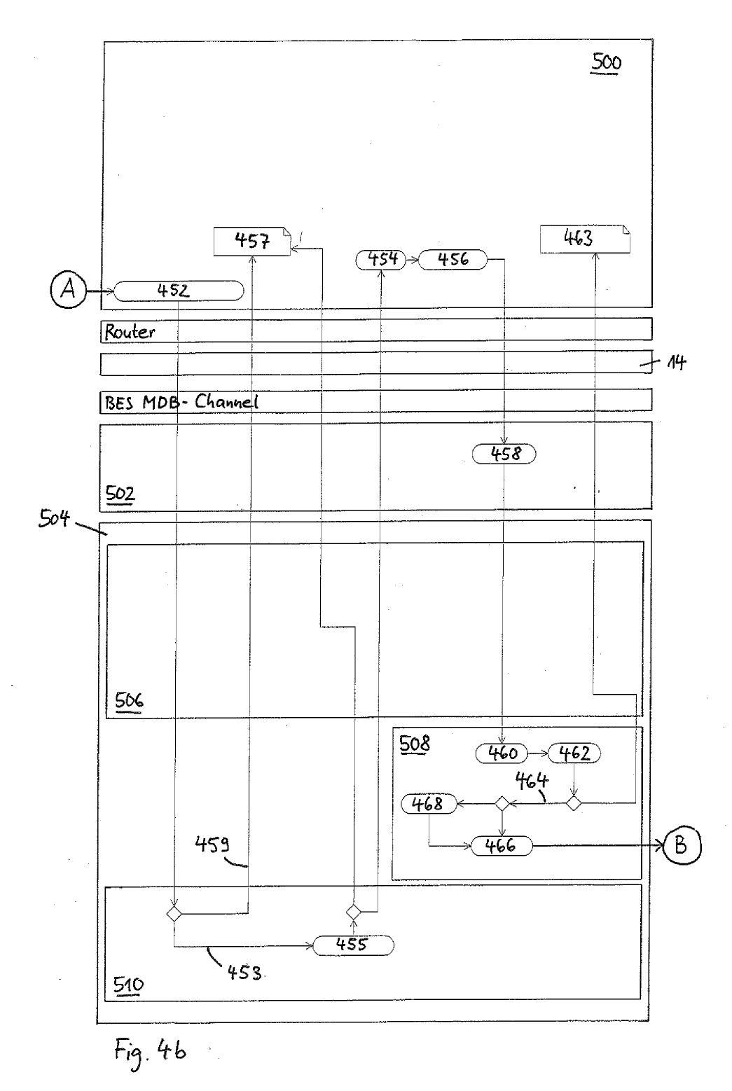

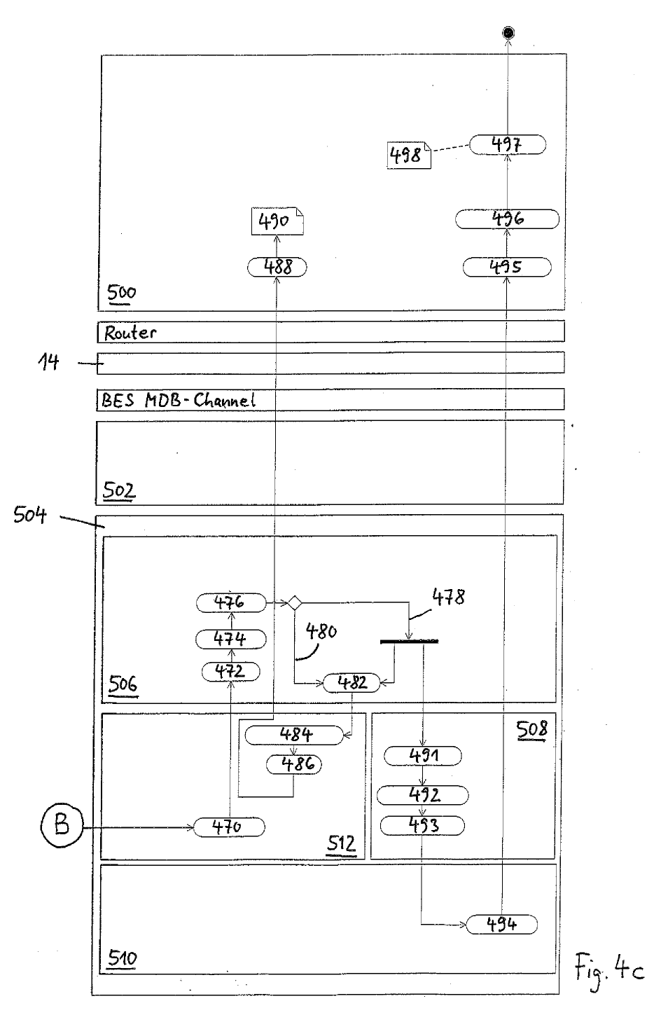

The publishing service 506 can be a Web service for managing the printable file types and to call the corresponding application and to generate the print object for the received e-mails (and attachments) to be printed (see also the diagram of FIG. 4).

The mail service 512 can be used to detach (in step 468) the mail attachment from the e-mail and to temporarily store the attachments, in step 466, on the server of the OPS.

The mail service 512 is also responsible for user administration and license verification 464, because the e-mail address of each BlackBerry user authorized to print is stored.

The mail service 512 also includes a virtual printer driver which operates as an ASCII printer driver when the mail text is printed.

The connection service 510 is used to transmit the print data to the e-mail-push-enabled terminal 27.

The .print Engine 508 receives the print orders from the Publishing Service, renders in step 491 the print orders and transmits the print orders in step 493 to the connection service 510, which in turn transmits in step 494 the print orders to the BlackBerry terminal 27.

The BlackBerry terminal 27 includes a Content Beamer Client 29, 500 enabling transfer of the print data to a Bluetooth-enabled printer 28.

The components of the OPS are integrated in the environment of the BlackBerry server 23 so as to be able to use the client module 29, 500 for BlackBerry devices.

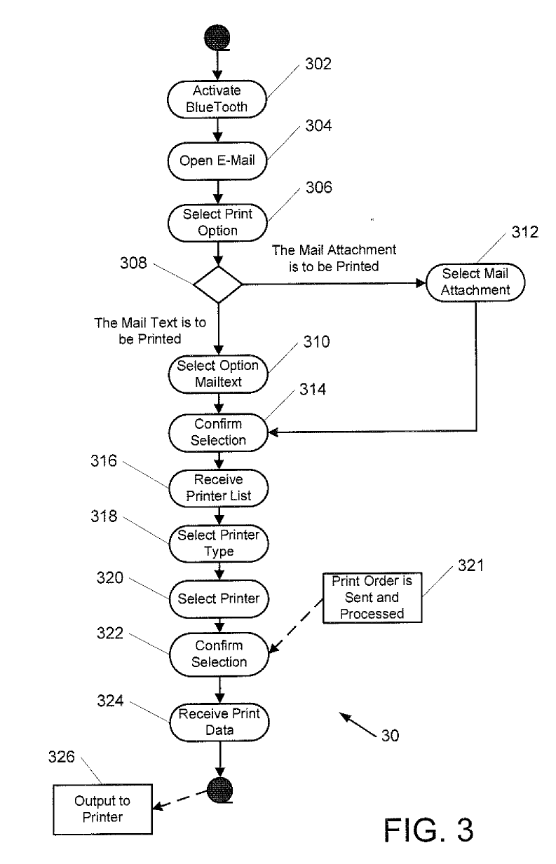

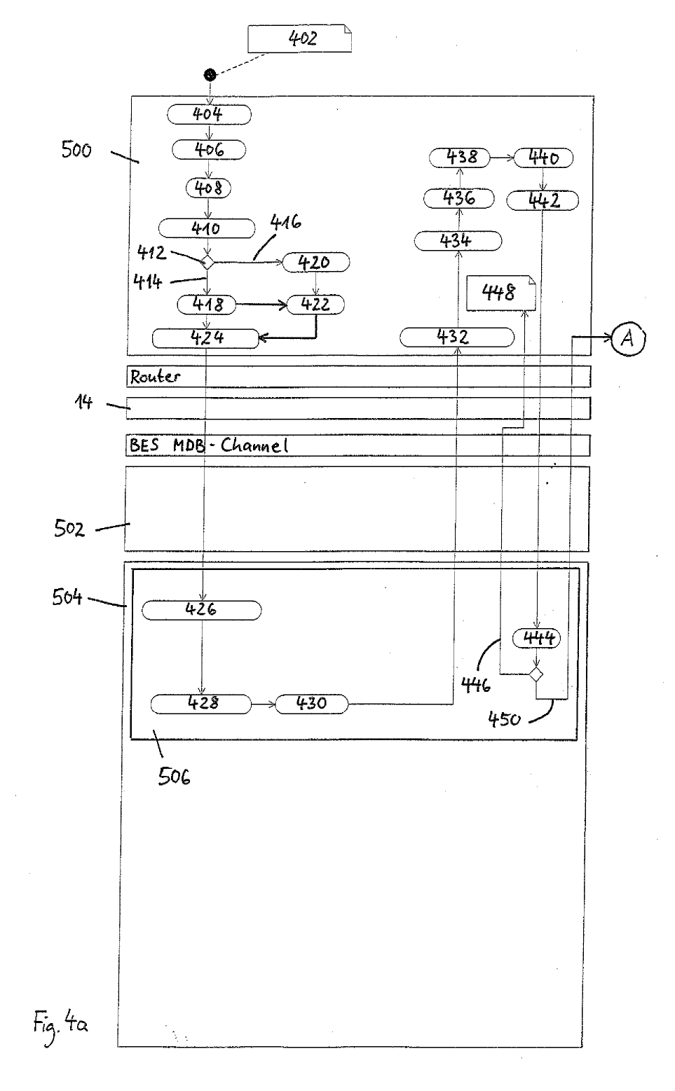

FIG. 3 and (in greater detail) FIG. 4 illustrate an exemplary process flow 30, as viewed by the user, for printing e-mails and e-mail attachments with an e-mail-push-enabled terminal.

To print an e-mail text and an e-mail attachment, at step 404, the Bluetooth application is configured, at step 302, 406, the Bluetooth application is activated and, at step 304, 408, the corresponding e-mail is selected and opened on the e-mail-push-enabled terminal, such as a BlackBerry device.

After an e-mail has been selected and opened in step 304, 408 on the e-mail-push-enabled terminal, the function “Print” is selected in an “Options” menu. The application “Print E-Mail” is divided into “Print E-Mail Text” and “Print E-Mail Attachment.” After selecting the option “Print”, at step 306, 410, a query is made at step 308, 412, if an e-mail text 414 or an attachment 416 included in this e-mail is to be printed.

If the option “Print E-Mail Text” can be selected at step 310, 418, or alternatively the option “Print E-Mail Attachment” can be selected at step 312, 420. The user then confirms the selection, at step 314, 422, and process 30 goes to step 316, where details of the printer setup are specified.

Before describing the subsequent steps of process 30, the necessary system requirements for implementing these steps will now be described.

Referring back to FIG. 2, the BlackBerry terminals 27 (only one terminal is shown so as not to overcomplicate the drawing) include a client module 29 for the e-mail-push service, such as the Content Beamer Client 29, in the form of executable files which can run on the e-mail-push-enabled terminals (for example, as files in the formats *.alx or *.cod for the BlackBerry terminals). These files can be downloaded to the terminal from the homepage of a provider of the additional print option, or transferred to the terminal via the BlackBerry desktop software or via an Over-The-Air (OTA) interface from a server of the e-mail push service.

The print function is installed on the e-mail-push-enabled terminal 27 by executing the installation file for the client module 29.

The configuration data are stored in the User Policies of a server of the e-mail-push service, such as server 22, from where they are transferred to the terminals 27.

The following configuration data of the OPS are stored and/or used:
Server:

Name or IP address of the server of the OPS
Port:

Name of the port used to connect to the server of the OPS (or to the component Connection Service)
The PIN of the BlackBerry terminal is transmitted for connection to and authentication on the server of the OPS
Mail service address:

E-mail address for the mail service; the e-mails or e-mail attachments to be printed are routed to the e-mail address

At the end of the installation, the client module 29 is automatically started and provides a print function after an e-mail is opened.

Returning now to the process flow diagram 30 of FIG. 3 and to FIG. 4, after the e-mail text or optionally the e-mail attachment, if included, has been selected in steps 310/418, 312/420 for printing and the selection is confirmed at step 314, 422, a configuration request is transmitted in step 424 to the Publishing Service 506 of the server 504 of the OPS. The configuration request queries all required configuration data and a directory of the available printer types.

If the connection to the server 504 of the OPS was successfully set up, the component Publishing Service 506 returns in step 428 the following information to the e-mail-push-enabled terminal after receipt (in step 426) of the configuration request:
Number of the stored printer types
Directory of the stored printer types 430
Server (Connection Service)
Port (Connection Service)
Additional information for controlling the transmission, such as timeout information

If the connection and the query were successfully set up, i.e. if configuration data (including the directory of the stored printer types 430) were transmitted in step 428 from the Publishing Service 506 and received in step 432, 434 from the Client Module 500, a printer directory is received, at step 316, and displayed to the user on the e-mail-push-enabled terminal. At step 318, 436, the user can select the corresponding printer type and, at step 320, 454, the printer. The selection is either confirmed, at step 322, or if the connection to the server 504 of the OPS was not successfully set up, a corresponding message is displayed to the user.

A connection to the server may fail, for example, because the server could not be reached, i.e., the Connection Service could not be reached with the provided IP address. Another attempt may be made to establish a connection. It may also happen that the configuration files have errors or are incomplete, in which case the configuration data need to be changed by the administrator of the e-mail push service.

After confirming (in step 322) the selection of the printer type at step 318, 436, a list with the attached Bluetooth printers is displayed to the user, from which the desired printer can be selected, a step 320, 438. It will be understood that prior activation (in step 404) of the Bluetooth interface of the e-mail-push-enabled terminal is required, as described above with reference to step 302. In a preferred embodiment, the user can link the Bluetooth printer ahead of time with the e-mail-push-enabled terminal.

If selection in step 440 was successful, an upload request is transmitted in step 442 to the component Publishing Service 506 and the print order is processed, at process 321. This upload request includes the selected printer type and the filename of the objects to be printed (e-mail text and optionally e-mail attachment). The Publishing Service 506 checks in step 444, if the file type of the e-mail text is a file type, which is supported by the Publishing Service 506. In one embodiment, the e-mail text is converted to a predetermined file type, for example the file type .txt. It can then be checked ahead of time if the file type of the attachment is supported by the OPS. If the Publishing Service 506 was not configured for the file type of the e-mail attachment (alternative 446), a corresponding message is sent in step 448 to the user, and the process is terminated. If the file types are supported (alternative 450), a connection to the Connection Service 510 on the server 504 of the OPS is subsequently set up in step 452.

If the connection to the Connection Service 510 was successfully established 453, the access data are checked, in step 455. A corresponding message is displayed to the user, step 457. Also in the case the connection to the Connection Service 510 was not successfully established 459, a corresponding message is displayed to the user, step 457.

If the option “Print E-Mail Text” was selected in steps 310, 414, the e-mail is uploaded in step 456 to the server 22, 504 of the OPS after selection of a printer type in step 318, 436 and after selection of a printer in step 320, 454.

The e-mail, which is either generated or initiated by the client module 29, 500 in the background, is sent from the server 23, 502 of the e-mail-push service to the component Mail Service 512. When the e-mail text is printed, the client module 29, 500 generates an e-mail with the e-mail text as .txt attachment which is sent in step 458 to the Mail Service 512. If an attachment 312, 416 is to be printed, the corresponding e-mail including the attachment is sent in step 458 to the Mail Service 512.

When the e-mail is received in step 460, the Mail Service 512 checks in step 462 if the required licenses exist on the 504 server of the OPS for that client and if the licenses are valid.

If license verification is successful 464, a corresponding status message is displayed to the user in step 463, and after the attachment was detached in step 468 from the e-mail, the e-mail text and/or the e-mail attachment are temporarily stored in step 466 by the Mail Service 512 on the server 504 of the OPS as a .txt file.

Information about the storage location is transmitted in steps 470 (send upload request), and 472 (receive upload request) to the component Publishing Service in the upload request together with information about the file type and the selected printer type. A corresponding printer object is generated in step 474, and the e-mail (e-mail text or e-mail attachment) is fetched, parameterized with the corresponding application and with a reference to the printer object (the aforementioned virtual printer driver is used as ASCII driver for e-mail text), step 476. A print order is generated which is transmitted to the .print Engine 508 which is also installed on the server 504 of the OPS (see process 321).

A status message about the current status of the process (success 478 or fail 480) is returned in step 482 to the Mail Service 512 during the upload. The Mail Service 512 generates in step 484 status information and transmits in step 586 this status information to the sender (i.e., the e-mail-push-enabled terminal) of the print order, where the client module 29, 500 receives in step 488, reads the status mail, and displays in step 490 a corresponding status message to the user.

If a print job was successfully generated, the .print Engine 508 renders in step 491, compresses in step 492 the transmitted print data on the server of the OPS, and transmits in step 493 the print data with a controlled bandwidth to the e-mail-push-enabled terminal, at step 324. The transmission takes place via the component Connection Service 510.

The print data are transmitted 494 to the e-mail-push-enabled terminal 27 in packets, i.e., streamed, where the packets are received in step 324, 495, decompressed 496 and transmitted onward to the selected Bluetooth printer, at step 326, 497. In an embodiment of the invention the e-mail-push-enabled terminal 27 displays in step 498 information about the progress of the printing process.

Licensing

The functionality of BlackBerry devices, enhanced with a print option, can be licensed by either obtaining a site license “Print Option BlackBerry (Corporate Edition)” when using server components. The site license requires that all components of the OPS are installed on a single server (typically the server on which the BlackBerry Enterprise Server is installed). Alternatively, an end-user license “Client Module” (Connected Client) can be obtained for each BlackBerry user.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method for printing data using a message signaling service (MSS), comprising the steps of:
signaling to a mobile terminal that data have been received at a server of the message signaling system (MSS);
the mobile terminal accessing the received data using a mobile radio link and transmitting a request for printing the data to the MSS server or to a data processing system which controls printing;
causing a computer program installed on the MSS server or on the data processing system to automatically initiate transmission of the requested data from the MSS server to a print server;
starting a printing process on the print server to generate print data; and
transmitting the print data from the print server to the mobile terminal and from the mobile terminal to a predetermined printer, where the print data are printed.

2. The method of claim 1, wherein the message signaling service (MSS) is an e-mail push service.

3. The method of claim 1, wherein the data received at the MSS server are e-mails, messages sent by Short Message Service (SMS), or messages sent via Multimedia Message Service (MMS), or a combination thereof.

4. The method of claim 3, wherein the e-mails include an e-mail attachment.

5. The method of claim 1, wherein the mobile terminal is an e-mail-push-enabled terminal.

6. The method of claim 1, wherein the mobile radio link includes a Global System for Mobile Communications (GSM) link, a General Packet Radio Service (GPRS) link, a Code Division Multiple Access (CDMA) link, or a Universal Mobile Telecommunications System (UMTS) link, or a combination thereof.

7. The method of claim 1, wherein the print server transmits the generated print data from the print server to the mobile terminal via a communication link established between the MSS server and the mobile terminal.

8. The method of claim 7, wherein the communication link between the MMS server and the mobile terminal uses a channel which is also used for communication between the mobile terminal and the MSS server.

9. The method of claim 1, wherein the mobile terminal automatically sets up a connection to the data processing system which controls printing, if the mobile terminal cannot be addressed by the server, to transmit the print data between the mobile terminal and the MSS server or between the mobile terminal and the data processing system, with the print data being transmitted to the mobile terminal via this connection.

10. The method of claim 1, wherein the generated print data are transmitted from the mobile terminal to the predetermined printer via a Bluetooth interface.

11. The method of claim 1, wherein the generated print data are transmitted from the mobile terminal to the predetermined printer via an infrared interface.

12. A system for printing data using a message signaling service, comprising
at least one server of a message signaling service (MSS server) and at least one mobile terminal communicating with the message signaling service via a mobile radio link, wherein data received on the MSS server are signaled to and accessible by the at least one mobile terminal;
wherein the system is configured to
transmit a request for printing the received data from the terminal to the MSS server or to a data processing system which controls printing,
automatically initiate transmission of the requested data from the MSS server to a print server by a computer program installed on the MSS server or on the data processing system,
starting a printing process on the print server to generate print data; and
transmitting the print data from the print server to the mobile terminal and from the mobile terminal to a predetermined printer, where the print data are printed.

13. A computer program embodied on a computer-readable medium enabling a computer, after the program is loaded into a memory of the computer, to execute a process for printing data using a message signaling service, said program causing the computer to
signal to a mobile terminal data when data are received on a server of a message signaling service (MSS server);
enable the mobile terminal to access the data received at the MSS server using a mobile radio link,
allow the terminal to send a request for printing the received data to the MSS server or to a data processing system which controls printing,
prompt a computer program installed on the MSS server or the data processing system to automatically initiate transmission of the requested data from the MSS server to a print server,
start a printing process on the print server to generate print data; and
transmit the print data from the print server to the mobile terminal and from the mobile terminal to a predetermined printer, where the print data are printed.

14. The computer program of claim 13, downloaded from an electronic data network to a data processing system connected to the data network.

15. The computer program of claim 14, wherein the data network the Internet.

16. A computer-readable storage medium storing a program which enables a computer, after the program is loaded into computer memory, to execute a process for printing data using a message signaling service, said process comprising the steps of:
signaling to a mobile terminal that data have been received at a server of the message signaling service (MSS);
the mobile terminal accessing the received data using a mobile radio link and transmitting a request for printing the data to the MSS server or to a data processing system which controls printing;
causing a computer program installed on the MSS server or on the data processing system to automatically initiate transmission of the requested data from the MSS server to a print server;
starting a printing process on the print server to generate print data; and
transmitting the print data from the print server to the mobile terminal and from the mobile terminal to a predetermined printer, where the print data are printed.

17. A method for extending a functionality of mobile terminals cooperating with a message signaling service having at least one message signaling server (MSS server), wherein the at least one MSS server signals to at least one mobile terminal cooperating with the message signaling service receipt of a message, the method comprising
providing a computer program for processing data suitable for output, with the computer program comprising at least three program modules, wherein
a first program module is installed on the MSS server,
a second program module is installed on the at least one mobile terminal cooperating with the message signaling service, and
a third program module is installed on a data processing system which controls printing, and
transmitting a request to print data from the at least one mobile terminal to the MSS server or to the data processing system,
automatically initiating with the first program module or the third program module a transmission of the requested data from the MSS server to a print server,
starting a printing process on the print server to generate print data, and
transmitting the print data from the print server to the at least one mobile terminal and from the at least one mobile terminal to a predetermined printer, where the print data are printed.

18. The method of claim 17, wherein the second program module is transmitted to the at least one mobile terminal from the MSS server via a wireless interface and automatically installed on the at least one mobile terminal.
